(19) United States
(12) Patent Application Publication
(10) Pub. No.: US 2004/0255515 A1
(43) Pub. Date: Dec. 23, 2004

(54) Method and apparatus for improving fuel combustion

(76) Inventor: Ronald L. Fenton, Mt. Prospect, IL (US)

Correspondence Address: Douglas B. White, Suite 802, 1901 N. Roselle Road, Schaumburg, IL, 60195, US

(21) Appl. No.: 10/894,258

(22) Filed: Jul. 19, 2004

Related U.S. Application Data
(63) Continuation-in-part of application No. 10/172,556, filed on Jun. 14, 2002.

(51) Int. Cl. C10K 1/00; B01F 3/02; F02M 21/02

(52) U.S. Cl. 48/189.3; 48/181; 48/189.1

(57) ABSTRACT

A tank containing an aluminum matrix and a combustible mixture includes the addition of a volume increasing diluter to a base fuel. A fuel tank, a tank of diluter and a tank of combustion enhancing additive are arranged to feed their respective products through control valves into an intermediate mixing tank. The mixed fuel is then metered into an individual consumer's tank which includes an interior aluminum mesh matrix.

### CROSS REFERENCE TO RELATED APPLICATIONS

This application is a continuation-in-part of prior co-pending U.S. patent application Ser. No. 10/172,556, filed Jun. 14, 2002.

### STATEMENT REGARDING FEDERALLY SPONSORED RESEARCH OR DEVELOPMENT:

Not Applicable

### BACKGROUND OF THE INVENTION

1. Field of the Invention

The present invention relates generally to fuels used for combustion in engines, such as propane, gasoline and the like. More particularly, this invention relates to a method for more effectively increasing the fuel volume and improving the combustibility of the fuel by adding and suspending a diluter in the fuel with the use of a metallic matrix in a tank.

2. Description of the Prior Art

In the prior art, fuel in an undiluted state is typically pumped or fed from a tank to a combustion chamber in an engine. There the fuel is ignited and the energy of the combustion is extracted and used to operate machinery. For example, in the automotive field, gasoline (traditionally the most commonly used fuel for vehicles) is pumped to an engine where is it is mixed with oxygen from ambient air and ignited. The resulting combustion of the gasoline acts to power the engine but leaves extensive hydrocarbons, nitrogen oxides and carbon monoxide as polluting byproducts.

Due to its cleaner combustion, propane has emerged in recent years as a cleaner alternative to gasoline for vehicles. As a result, some vehicles have been converted to use propane, and some vehicles now even have dual systems to permit the switching between gasoline and propane systems. Alternatively, CNG (compressed natural gas), methanol, and ethanol are also in use for powering engines, but are not as effective as propane. While switching to a cleaner alternative, such as propane, will help reduce air pollution, it has become quite clear that only a reduction in the amount of fuel burned will ultimately reduce emissions. This has given rise in recent years to public efforts to reduce vehicle usage and to increase vehicle mileage. More recently, in U.S. Pat. No. 5,823,758, FUEL COMBUSTION ENHANCING CATALYTIC COMPOSITION AND METHODS OF FORMULATING AND UTILIZING SAME, there was described a catalytic fuel additive, known commercially as CGX-4. By mixing such an additive into the fuel, combustion takes place more completely and more effectively, thereby improving combustion efficiency and reducing pollution.

### SUMMARY OF THE INVENTION

The object of the present invention is to further reduce pollution resulting from the combustion of fuels and to further economize on fuel consumption by extending the combustive usefulness of a given volume of fuel.

These and other objects are accomplished by employing a method for diluting and enhancing fuel by the addition of a volume increasing diluter into a tank having an aluminum foil mesh matrix positioned therein to act as a catalyst.

The aluminum mesh matrix is formed from an expanded aluminum mesh grid, which is either formed into multiple packets for insertion into the tank, or otherwise rolled or folded to fit within the tank. When the mixture of diluter and fuel is added to the tank the aluminum matrix serves to trap the diluter and to hold it in suspension. Moreover, the aluminum matrix acts as a catalyst to improve the suspension of the fuel/diluter mixture. This is believed to be due in part to the interaction of the positively charged molecules of the diluter with the aluminum matrix.

As a consequence of using this combustible mixture, less fuel (whether propane, gasoline, CNG, or other fuel) will be consumed, and this results in improved efficiency and reduced pollution emissions. In automobile terminology, such an enhanced fuel composition resulting from the method of this invention will burn cleaner and improve vehicle mileage.

### BRIEF DESCRIPTION OF THE DRAWINGS

FIG. 1 is a depiction of one embodiment of the apparatus employed for the mixing of the diluted fuel mixture in accordance with the method of the present invention.

FIG. 2 is an illustration of a portion of the expanded aluminum sheet mesh used to form the aluminum matrix within the tank.

FIG. 3 is an illustration of a packet formed from the aluminum mesh of FIG. 2.

FIG. 4 is an illustration of a tank (partially cut away) showing packets of aluminum mesh positioned therein.

FIG. 5 is an illustration of a tank (partially cut away) showing an aluminum mesh sheet rolled or folded and positioned therein.

While the invention will be described in connection with a preferred embodiment, it will be understood that it is not the intent to limit the invention to that embodiment. On the contrary, it is the intent to cover all alternatives, modifications, and equivalents as may be included within the spirit and scope of the invention as defined by the appended claims.

### DESCRIPTION OF THE PREFERRED EMBODIMENT

The method and apparatus described herein increases the volume and improves the combustibility of a combustible liquid or gaseous fuel by the suspension of an added diluter in the fuel. This addition of a diluter is optionally accompanied by a combustion enhancing additive. As will be discussed in detail below, the diluter, the additive, and the base fuel are mixed and injected into a tank having a matrix of aluminum mesh positioned therein. By injecting and then suspending a quantity of the diluter into the fuel, less volume of the original fuel is required to obtain acceptable combustibility and emission results.

In the preferred embodiment of the present invention, the diluter comprises a combustible gas for a gaseous fuel or a combustible liquid for a liquid fuel. Alternatively, this diluter may also include oxidizing components, such as oxygen gas in the gaseous version.

The combustion enhancing additive, in the preferred embodiment, comprises a catalytic composition, such as the CGX-4 additive described in U.S. Pat. No. 5,823,758, entitled “FUEL COMBUSTION ENHANCING CATALYTIC COMPOSITION AND METHODS OF FORMULATING AND UTILIZING SAME”. This catalytic composition employs a metal oxide catalyst dispersed in an organic carrier.

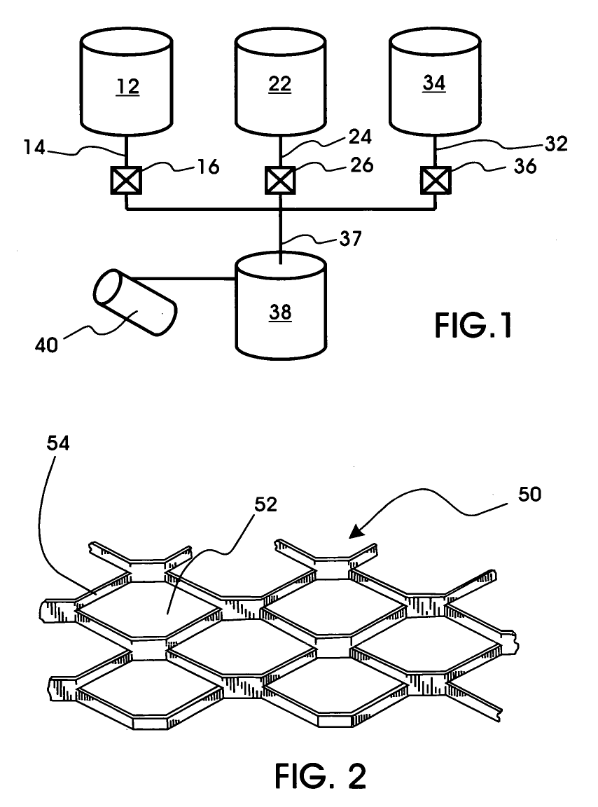

Typical apparatus for accomplishing the method of the present invention to produce the combustible mixture described herein is generally depicted in FIG. 1. Particularly, in the embodiment shown, a tank 12 of the base fuel is arranged to feed a predetermined measured quantity of fuel through its outlet pipe 14 and a control valve 16. Similarly, a tank 22 of diluter feeds a predetermined measured quantity of diluter through its outlet 24 by way of a control valve 26. Finally, an outlet pipe 32 from a tank 34 of an optional combustion enhancing additive likewise, if desired, feeds a predetermined measured quantity of additive through a controlled valve 36. In the preferred embodiment the above-mentioned control valves are electronically calibrated and electronically controlled to provide the desired ratio of the volumes of diluter and fuel enhancing additive to the volume of the base fuel.

The components of the mixture fed through piping 37 to a staging tank 38 where they are combined. From this intermediate staging tank the mixture is metered to the individual consumer's tank 40. Alternatively, the mixture may be injected directly into the consumer's tank 40, omitting the intermediate staging tank.

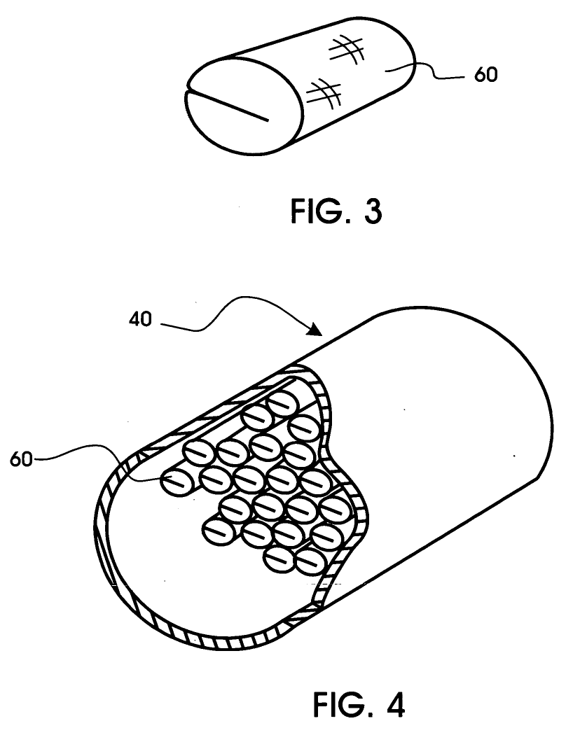

Turning now to FIG. 2 there is shown a portion 50 of a sheet of metallic mesh grid, which mesh is now well known in the art (see for example U.S. Pat. No. 3,356,256). This mesh grid is typically formed from a sheet of aluminum which is provided with an array of slits and then expanded into the mesh grid. Once expanded this mesh grid displays open areas 52 surrounded by aluminum walls 54. When folded or rolled, this sheet forms a matrix having interior spaces substantially surrounded by aluminum walls. A packet 60 of mesh matrix, formed from the folded and/or rolled aluminum mesh sheet of FIG. 2, is shown in FIG. 3. Such packets are described in detail in U.S. Pat. No. 6,604,644.

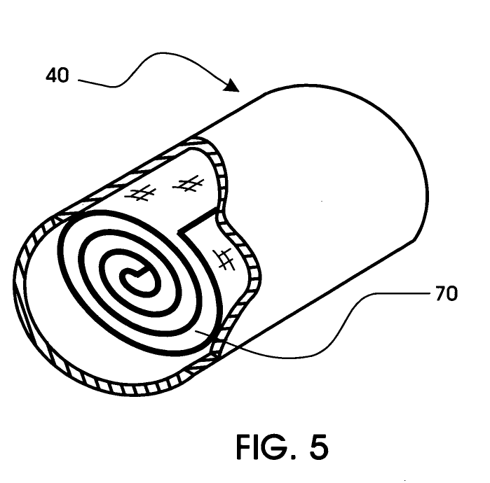

To create the filler matrix within the tank, the interior of the tank 40 of FIG. 1 is substantially filled with the filler packets 60 (see FIG. 4) or with a folded or rolled mesh sheet 70 (see FIG. 5). Similarly, the intermediate tank 38 may be provided with an interior filler matrix to improve suspension of the diluter within that tank. Consequently, when the fuel is added to the tank, the matrix serves to trap and suspend the diluter. Moreover, the aluminum matrix acts as a catalyst to improve this suspension in the fuel/diluter mixture. This is believed to be due in part to the interaction of the positively charged molecules of the diluter with the aluminum of the matrix.

It has been found that when using a propane fuel and a combustion enhancing additive, such as CGX-4, and when the mixture is held in a tank having an aluminum mesh matrix, a diluting gas can be added to the mixture at a concentration of greater than 25% and retained therein in suspension.

In a further aspect of this method, it has been found that by using air as the diluter, which contains an oxidizing component (oxygen), with a propane fuel, the propane can be diluted by the method of the present invention at a ratio of greater than 24 cubic feet of air per cubic foot of propane.

From the foregoing description, it will be apparent that modifications can be made to the apparatus, method, and product without departing from the teachings of the present invention. Accordingly, the scope of the invention is only to be limited as necessitated by the accompanying claims.

What is claimed is:

1. A tank of combustible mixture comprising:
a tank body having a metallic mesh matrix positioned therein; and
a combination of a fuel and a diluter within said tank.

2. The tank of claim 1 further comprising a combustion enhancing additive added to said combination of fuel and diluter, wherein said combustion enhancing additive comprises a catalytic composition.

3. The tank of claim 2 wherein said catalytic composition comprises a metal oxide catalyst dispersed in an organic carrier.

4. The tank of claim 1 wherein said fuel comprises propane.

5. The tank of claim 4 further comprising a combustion enhancing additive added to said combination of fuel and diluter, wherein said combustion enhancing additive comprises a catalytic composition.

6. The tank of claim 5 wherein said catalytic composition comprises a metal oxide catalyst dispersed in an organic carrier.

7. The tank of claim 5 wherein said diluter comprises greater than 25% of the mixture.

8. The tank of claim 4 wherein said metallic mesh matrix comprises packets of aluminum mesh.

9. The tank of claim 4 wherein said metallic mesh matrix comprises one or more sheets of aluminum mesh rolled or folded to substantially fill the interior of said tank.

10. The tank of claim 1 wherein said fuel comprises propane and said diluter comprises air.

11. The tank of claim 10 wherein the ratio of air diluter to propane fuel comprises greater than 24 cubic feet of air to 1 cubic foot of propane.

12. The tank of claim 11 further comprising a combustion enhancing additive added to said combination of fuel and diluter, wherein said combustion enhancing additive comprises a metal oxide catalyst dispersed in an organic carrier.

13. A method for preparing a diluted combustible fixture from a volume of fuel, comprising the steps of:
injecting a predetermined measured quantity of a diluter and a predetermined measured quantity of fuel into a tank,
wherein said tank comprises a tank body, having an aluminum mesh matrix positioned therein.

14. A method for preparing a diluted combustible mixture of claim 13 further comprising injecting a measured quantity of a catalytic combustion enhancing additive into said tank, wherein said catalytic combustion enhancing additive comprises a metal oxide catalyst dispersed in an organic carrier.

15. A method for preparing a diluted combustible mixture of claim 14 wherein said diluter comprises greater than 25% of the mixture.

16. A method for preparing a diluted combustible mixture of claim 13 wherein said aluminum mesh matrix comprises packets of aluminum mesh.

17. A method for preparing a diluted combustible mixture of claim 13 wherein said aluminum mesh matrix comprises one or more sheets of aluminum mesh rolled or folded to substantially fill the interior of said tank.

18. A method for preparing a diluted combustible mixture of claim 13 wherein said fuel comprises propane and said diluter comprises air.

19. A method for preparing a diluted combustible mixture of claim 18 wherein said aluminum mesh matrix comprises packets of aluminum mesh.

20. A method for preparing a diluted combustible mixture of claim 18 wherein said aluminum mesh matrix comprises one or more sheets of aluminum mesh rolled or folded to substantially fill the interior of said tank.
